(19) United States
(12) Patent Application Publication
(10) Pub. No.: US 2009/0271078 A1
(43) Pub. Date: Oct. 29, 2009

(54) SYSTEM AND METHOD FOR IDENTIFYING A TRAILER BEING TOWED BY A VEHICLE

(76) Inventor: Mike Dickinson, Hilliard, OH (US)

Correspondence Address: Emerson, Thomson & Bennett, LLC, 777 W. Market Street, Akron, OH, 44303, US

(21) Appl. No.: 12/111,403

(22) Filed: Apr. 29, 2008

(51) Int. Cl. G06F 19/00

(52) U.S. Cl. 701/51

(57) ABSTRACT

A system and method are disclosed for operating a vehicle towing a trailer including a camera that captures an image of a frontal surface of the trailer. A surface estimate component may be used to receive an image from the camera and generate an estimated area and shape of the frontal surface of the trailer. A type recognition component may be used to generate a trailer identification based on the estimated area and shape. A cross reference component may be used to retrieve correlated information related to the trailer based on the trailer identification. A vehicle control interface may be used to transmit the correlated information to an on-board vehicle control unit, to modify the operation of the vehicle according to the correlated information.

### I. BACKGROUND OF THE INVENTION

A. Field of Invention

This invention generally relates to methods and apparatuses related to camera systems used in motor vehicles and more particularly to methods and apparatuses related to rearwardly-facing camera systems for assisting in the performance of the vehicle in the response to variable conditions.

B. Description of the Related Art

The performance of motor vehicles can be greatly affected by towing a trailer. The additional weight of the trailer, while either empty or fully loaded, places an additional load on the vehicle's drive train. In addition to requiring extra work to be performed by the motor, the shift cycle of an automatic transmission can be affected. Towing a trailer can also interfere with cruise control feedback gains. The additional momentum of the trailer reduces the responsiveness and effectiveness of the vehicle's brake system, particularly on hills or in traffic situations where rapid braking is required. Further, a loaded trailer is prone to sway and move along the road, affecting the vehicle's steering and suspension. Also, the trailer contributes aerodynamic drag as a function of the vehicle speed, which also affects performance and fuel economy.

In addition to the aforementioned difficulties, certain of the various problems associated with trailers in general can be exacerbated by specific types of trailers. For example, some trailers are long and ride low to the ground. Other types of trailers are short and ride high. Each of these trailer types can carry different loads and distribute the weight differently. Some trailers can carry a load high, which affects the center of gravity and can cause rocking and swaying. Long trailers can sway horizontally on the road. Open trailers have a different aerodynamic function than enclosed trailers. While most trailer types are for hauling various types of gear or cargo, other trailers are for recreational purposes. Each trailer type can have a different effect on the performance of the towing vehicle.

Currently available vehicles employ active systems to compensate for performance variables. For example, systems including the automatic transmission, brake system, suspension, and motor functions are regulated by a sensor network that feeds back to an electronic control system. The additional load and performance factors created by towing a trailer can create difficulties in the operation of the control system.

Depending on the use and application, a specific vehicle may be used regularly to tow a variety of different type trailers. Each trailer and load can place its own particular wear and tear “signature” on the vehicle, and the combined effect of over time can contribute greatly to the maintenance requirements of the vehicle and can shorten its useful life.

In order to overcome these difficulties, methods and apparatuses are needed that would enable a vehicle's on-board electronic control systems to compensate for the additional performance variables that result from towing a trailer.

### II. SUMMARY OF THE INVENTION

Some embodiments of the present invention relate to a system for operating a vehicle towing a trailer including a camera that captures an image of a frontal surface of the trailer. A surface estimate component is provided that receives an image from the camera and generates an estimated area and shape of the frontal surface of the trailer. A type recognition component generates a trailer identification based on the estimated area and shape. A cross reference component retrieves correlated information related to the trailer based on the trailer identification. A vehicle control interface transmits the correlated information to an on-board vehicle control unit, to modify the operation of the vehicle according to the correlated information.

Other embodiments of the present invention relate to a method of operating a vehicle towing a trailer. An image is captured of a frontal surface of the trailer. An area and shape of the frontal surface of the trailer is estimated from the captured image. A type of trailer is identified from the estimated area and shape of the frontal surface of the trailer. Correlated information is retrieved related to the trailer based on the type of trailer identified. The correlated information is transmitted to an on-board vehicle control unit. The operation of the vehicle is modified according to the correlated information.

Still other embodiments of the present invention relate to a system of operating a vehicle towing a trailer. Means are provided for capturing an image of a frontal surface of the trailer. Means are also provided for estimating an area and shape of the frontal surface of the trailer from the captured image. Other means are provided for identifying a type of trailer from the estimated area and shape of the frontal surface of the trailer. Additional means are provided for retrieving correlated information related to the trailer based on the type of trailer identified. Means are further provided for transmitting the correlated information to an on-board vehicle control unit. Means are then provided for modifying the operation of the vehicle according to the correlated information.

Other benefits and advantages will become apparent to those skilled in the art to which it pertains upon reading and understanding of the following detailed specification.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a side view depicting a vehicle towing a trailer and having a rearwardly facing camera system in accordance with the present invention.

FIG. 2 illustrates the field of view of a rearwardly facing camera observing a frontal surface of the trailer, in accordance with the present invention.

FIG. 3 is a schematic view of a system for identifying a trailer being towed by a vehicle in accordance with the present invention.

FIG. 4 is a flow chart of a method of operating a vehicle towing a trailer in accordance with the present invention.

### IV. DETAILED DESCRIPTION OF THE INVENTION

The present invention generally relates to systems and methods for identifying a type of trailer being towed by a vehicle and providing information about the trailer to the vehicle's on-board electronic control system, so as to operate the vehicle towing the trailer. The invention includes a camera and a pattern recognition arrangement for identifying the front-facing surface of the trailer. This information may be referenced to a database of trailer types and cross-referenced to another database containing various parameter information for each trailer type. This parameter information is processed by the vehicle's electronic control system, so as to compensate for the performance variations produced by the trailer.

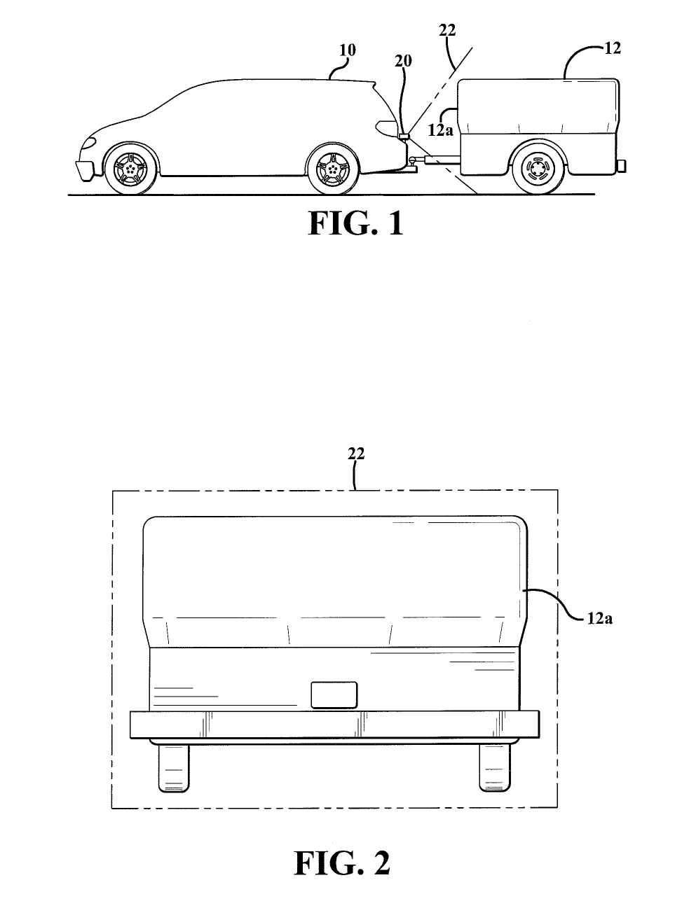

Referring now to the drawings wherein the showings are for purposes of illustrating embodiments of the invention only and not for purposes of limiting the same, and wherein like reference numerals are understood to refer to like components, FIG. 1 generally shows a vehicle 10 equipped with a camera 20 and towing a trailer 12. It should be understood that this invention will work well with any type of vehicle used to tow a trailer including, for some non-limiting examples, automobiles, trucks, buses, motorcycles, tractors and off-road vehicles. It should also be under that this invention will work well with any type of trailer having any type of load (including no load) chosen with sound engineering judgment.

With reference now to FIGS. 1-2, the camera 20 is used to capture an image of a frontal surface 12a of the trailer 12 and in this way is used to detect the presence of the trailer 12. The camera 20 may be of any type or style sufficient to capture the proper image and it may be positioned in any location and in any manner to properly acquire the image of a frontal surface 12a of the trailer 12. For the embodiment shown, the camera 20 is mounted on a rear outer surface of the vehicle 10. In alternate embodiments, the camera 20 may be positioned within the vehicle 10, mounted to the top or bottom of the vehicle 10, mounted to a side of the vehicle 10, and/or mounted to the trailer 12. It should also be appreciated that the camera 20 can be installed onto a vehicle during the manufacturing of the vehicle. In another embodiment, the camera 20 may be installed onto an existing vehicle in order to provide a rear view to the driver when backing the vehicle in reverse.

As shown in FIG. 2, the camera 20 has a field of view 22 that includes the frontal surface 12a of the trailer 12. In one embodiment, the camera 20 includes a wide angle lens that enables the entire frontal surface 12a to be perceived within the field of view 22. The image of the frontal surface 12a is captured and then may be processed by an electronic trailer identification system 30, as will be set forth in detail hereinbelow.

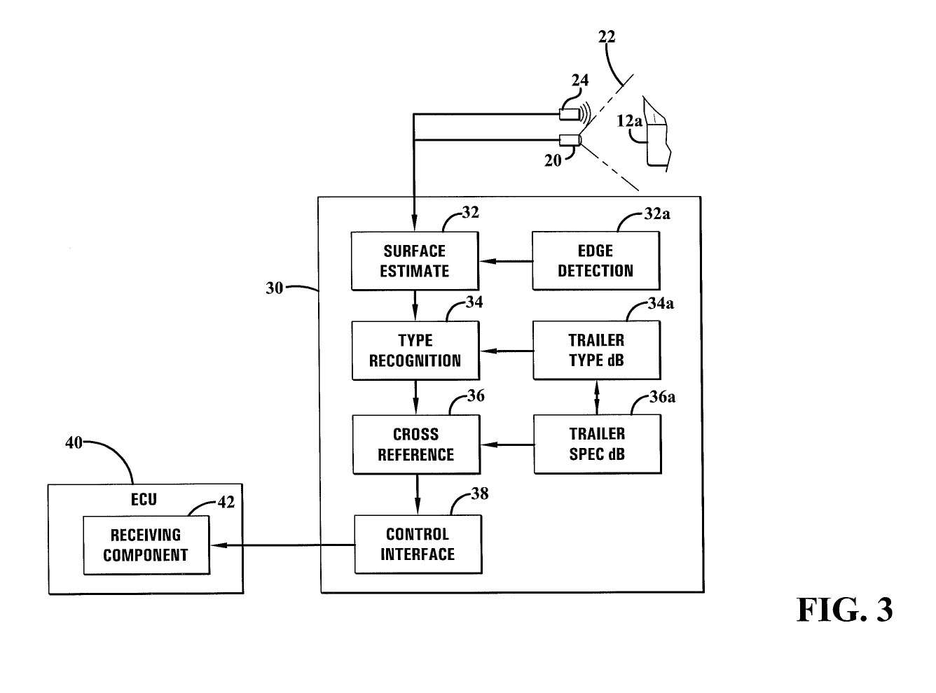

With reference now to FIGS. 1-4, the electronic trailer identification system 30 may comprise a microprocessor driven computer unit that receives image data from the camera 20 and uses this data to execute a number of functions related to the operation of the system. The system 30 may be, in one embodiment, a component of an on-board master computer system for a motor vehicle. In an alternate embodiment, the electronic system 30 may be a dedicated computer unit used strictly for determining a trailer type, as described herein. In connection with the electronic trailer identification system 30 of the present invention, it should be appreciated that a number of “components” are employed in the processing of data and the execution of the system as described herein. As used in this context, it should be understood that the term “component” is intended to refer to a computer-related entity, either hardware, firmware, a combination of hardware, firmware, and/or software, software alone, or software in execution. For example, a component may be, but is not limited to being, a process running on a processor, a processor per se, an object, an executable, a thread of execution, a program, a memory element or the memory data contained therein, and/or a computer. By way of illustration, both an application running on a computer and the computer itself can be a component. One or more components may reside within a process and/or thread of execution and a component may be localized on one computer and/or distributed between two or more computers. The system 30 can be a discrete hardware component installed separately during vehicle manufacturing or can be a component within a later to be described ECU 40. Alternatively, the present invention can be separately manufactured and retrofitted onto the vehicle 10 in an aftermarket procedure, all without departing from the invention.

With continuing reference to FIGS. 1-4, the image captured by the camera 20 may be forwarded to the system 30 and received by a surface estimate component 32 that receives the image from the camera 20 and generates an estimated area and shape of the frontal surface 12a of the trailer 12. In one embodiment, the surface estimate component 32 comprises an edge detection component 32a that detects boundaries of luminosity change in the image. The edge detection component 32a may be used to estimate the frontal area 12a of the trailer 12 using visual edge detection. In one embodiment, the visual edge detection is the type known in the art as “Canny edge detection.” The edge detection component 32a may employ an algorithm that analyzes a digital image to determine points in the image where intensity of luminosity changes sharply. Such sharp changes in the image properties indicate boundaries representing physical properties, including variations in depth, surface orientation, illumination, and material properties.

Still referring to FIGS. 1-4, in analyzing the image, the surface estimate component 32 determines the physical contour of the perimeter of frontal surface 12a, along with any distinguishing features (e.g. trailer hitch, running boards, wheel wells, stylistic variations in the surface, etc.) In this way, the surface estimate component 32 renders a digital representation of the frontal surface 12a of the trailer 12. In addition to the surface estimate component 32, the system 30 can optionally employ a proximity sensor 24 that estimates distance to the trailer 12. In one embodiment, the proximity sensor 24 is an acoustic/ultrasonic sensor that measures distance by the “time of flight” of a sound wave, as is known in the art. By judging the distance to the trailer 12, the proximity sensor 24 can be used in conjunction with the surface estimate component 32 to accurately estimate the actual size of the frontal area 12a of the trailer 12. In this way, the proximity sensor 24 assists in generating the estimated area and shape of the frontal surface 12a of the trailer 12.

With continuing reference to FIGS. 1-4, the processed image may be sent from the surface area component 32 to a type recognition component 34 that generates a trailer identification based on the estimated area and shape. The type recognition component 34 may include a trailer type database 34a that references a number of trailer types according to area and shape of their respective frontal surfaces. Each trailer type will have a distinctive size and contour, and data on each type is maintained in the trailer type database 34a. This database 34a can be pre-loaded with graphical or other type data files for each trailer type, and the database 34a can be periodically maintained when new trailer designs are added. The type recognition component 34 compares the processed image with the data files maintained in the database 34a to obtain a match. This can be performed using conventional pattern recognition techniques that statistically correlate similarities in contour features even if an exact point-for-point match cannot be obtained. This pattern recognition can compensate for discrepancies such as variations in viewing angle or damage to the trailer 12 that could affect its contour lines.

Still referring to FIGS. 1-4, once the type recognition component 34 determines the trailer type, a cross reference component 36 may retrieve correlated information related to the trailer based on the trailer identification. In one embodiment, the cross reference component 36 includes a trailer specification database 36a that maintains the correlated information of trailer specifications. The correlated information can include any number of parameters of the trailer, such as empty trailer weight or the full trailer weight capacity, so as to allow the system 30 to anticipate a weight range. The database 36a can also include correlated information such as the center of gravity of the trailer, empty and/or full. Correlated information can also include aerodynamic drag of the trailer 12 as a function of vehicle speed. The trailer specification database 36a can be a separate component or can reside within a common database component shared by the trailer type database 34a, and may represent one or more database tables within the common database component. In any event, the trailer type database 34a and the trailer specification database 36a may communicate with each other and cross reference data on each type of trailer 12.

With continuing reference to FIGS. 1-4, once the correlated information for the determined trailer type is obtained, this information is received by a vehicle control interface component 38 that that transmits the correlated information to an on-board vehicle electronic control unit (ECU) 40, to modify the operation of the vehicle according to the correlated information. The vehicle control interface component 38 can format the correlated information into a form best usable by the ECU 40. In another embodiment, the vehicle control interface component 38 can function as a “modem” to send the correlated information in a manner best suitable for transmission (such as, wirelessly or over a wire in analog or digital format) to be formatted at the ECU 40. The on-board vehicle control unit 40 may include a receiving component 42 for receiving and processing the correlated information. The receiving component 42 can be, according to one embodiment, a system interface and or a modem for receiving data from the vehicle control interface component 38. In another embodiment, the receiving component 42 can receive “raw” data from the vehicle control interface component 38 and format the data into a suitable form to be used by the ECU 40.

Still referring to FIGS. 1-4, the correlated information received by the receiving component 42 may be used to modify drive train control functions performed by the ECU 40. These drive train functions may be algorithms executed by the ECU 40 in the operation of the vehicle. These algorithms can include more or more controls for one or more vehicle systems. These controls can include automatic transmission timing logic, active suspension and brake controls for sway dampening, engine power vs. fuel consumption adjustments, and cruise control feedback gains. The ECU 40 may execute these algorithms in the operation of the motor vehicle. By receiving the correlated information, the ECU 40 is able to modify the vehicle operation and performance so as to compensate for the additional load, motions, resistance factors, and other physical variables created by towing the trailer. In this way, the present invention improves safety, increases engine efficiency and fuel economy, and compensates for wear and tear on the vehicle.

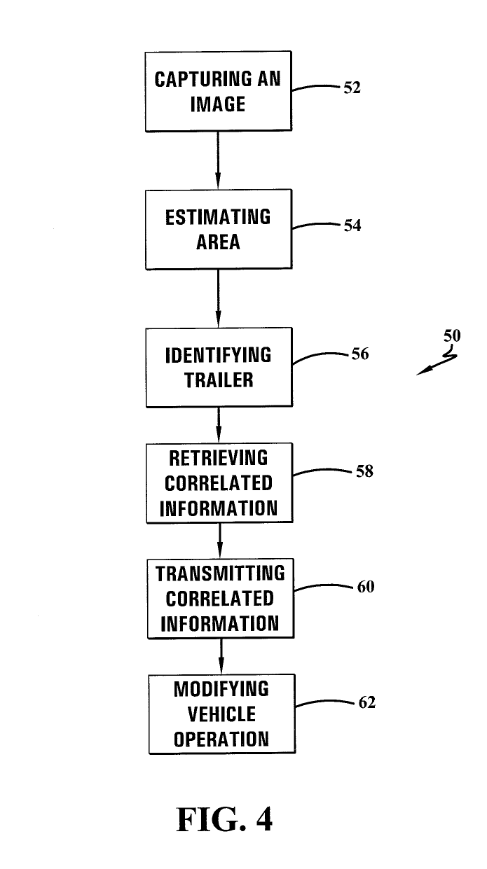

FIG. 4 illustrates the steps in a method 50 of operating a vehicle towing a trailer. A step 52 is performed of capturing an image of a frontal surface of the trailer from a rear portion of the vehicle. The image may be captured with a rearwardly facing camera mounted on the vehicle. As noted above, the camera may be installed on the vehicle during manufacture or may be subsequently installed in an aftermarket procedure. A step 54 is performed of estimating an area and shape of the frontal surface of the trailer from the captured image. This estimating may be performed by detecting the edges of the frontal surface of the trailer. In one embodiment, this is performed by detecting boundaries of luminosity change in the image, where such boundaries can indicate any physical properties such as variations in depth, surface orientation, illumination, and material properties. The step 54 of estimating the area and shape can also, in another embodiment, include estimating the distance to the trailer. This distance estimation may be performed by acoustically measuring the distance, with an acoustic/ultrasonic sensor that uses conventional “time of flight” techniques for determining the distance, traveled by the sound wave.

With continuing reference to FIG. 4, a step 56 is performed of identifying a type of trailer from the estimated area and shape of the frontal surface of the trailer. Since each trailer has a distinctive frontal contour, the image analysis will result in an image having a unique profile as compared with other trailers. The step 56 of identifying may include a process of referencing the area and shape of frontal surfaces of a number of different trailer types retained in a trailer type database.

Still referring to FIG. 4, another step 58 is performed of retrieving correlated information related to the trailer based on the type of trailer identified. This retrieving step 58 may include referencing trailer specifications associated with the identified trailer type retained in a trailer specification database. The specifications in the database can include numerical values for empty trailer weight, trailer weight capacity, center of gravity, and aerodynamic drag as a function of vehicle speed. This data can be provided by the trailer manufacturers or determined by an independent testing agency. This data can be preloaded into a processing system during manufacture, and can be updated as new trailers are released.

With continuing reference to FIG. 4, a step 60 is performed of transmitting the correlated information to an on-board vehicle control unit. This transmitting can be done from a discrete component, and can sent wirelessly or over a wire, as an analog or digital signal, in any one of a number of suitable formats, as are known in the art. Alternatively, the entire process can be executed within the on-board electronic vehicle control unit, in which case the step 60 of transmitting entails sending data between internal components.

Still referring to FIG. 4, a step 62 is performed of modifying the operation of the vehicle according to the correlated information. This step 62 entails modifying some or all drive train control functions performed by the vehicle control unit. These drive train control functions can include one or more functions such as automatic transmission timing, active suspension and brake controls for sway dampening, engine power vs. fuel consumption adjustments, and cruise control feedback gains.

With reference now to FIGS. 1-2, as used above the word “trailer” refers to the vehicle designed to be hauled or towed by the vehicle 10. However, it is also contemplated in an alternate embodiment to permit the frontal surface 12a to include not only the trailer but the load carried by the trailer. In this case, for one non-limiting example, the word “trailer” may refer to the combination of a boat trailer and the boat which it carries.

The present method allows for greater control over a vehicle towing a trailer. The present method thus allows for improved vehicle performance, with improved safety, engine efficiency and fuel economy, and reduced wear and tear on the vehicle and its systems.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

1. A system for operating a vehicle towing a trailer comprising:
a camera mounted on the vehicle or the trailer that captures an image of a frontal surface of the trailer;
a surface estimate component that receives an image from the camera and generates an estimated area of the frontal surface of the trailer;
a cross reference component that retrieves correlated information related to the trailer based on the estimated area; and
a vehicle control interface component that transmits the correlated information to an on-board vehicle control unit, to modify the operation of the vehicle according to the correlated information.

2. The system of claim 1, wherein the surface estimate component comprises an edge detection component that detects boundaries of luminosity change in the image.

3. The system of claim 1, further comprising:
a proximity sensor that estimates distance to the trailer, the proximity sensor being used in conjunction with the surface estimate component to generate the estimated area of the frontal surface of the trailer.

4. The system of claim 1, wherein the proximity sensor comprises an acoustic proximity sensor.

5. The system of claim 1, wherein the cross reference component comprises a trailer specification database that maintains the correlated information of trailer specifications.

6. The system of claim 1, wherein the on-board vehicle control unit comprises a receiving component for receiving and processing the correlated information so as to modify drive train control functions performed by the vehicle control unit.

7. The system of claim 1, wherein:
the surface estimate component receives an image from the camera and generates an estimated shape of the frontal surface of the trailer; and,
the cross reference component also retrieves correlated information related to the trailer based on the estimated shape.

8. The system of claim 1, further comprising:
a type recognition component that generates a trailer identification based on the estimated area of the frontal surface of the trailer.

9. A method of operating a vehicle towing a trailer comprising the steps of:
(A) capturing an image of a frontal surface of the trailer;
(B) estimating an area and shape of the frontal surface of the trailer from the captured image;
(C) identifying a type of trailer from the estimated area and shape of the frontal surface of the trailer;
(D) retrieving correlated information related to the trailer based on the type of trailer identified;
(E) transmitting the correlated information to an on-board vehicle control unit; and
(F) modifying the operation of the vehicle according to the correlated information.

10. The method of claim 9, wherein step (A) comprises the step of:
capturing the image with a camera mounted on the vehicle.

11. The method of claim 9, wherein step (B) comprises the step of:
detecting the edges of the frontal surface of the trailer by detecting boundaries of luminosity change in the image.

12. The method of claim 9, wherein step (B) comprises the step of:
estimating distance to the trailer.

13. The method of claim 9, wherein step (C) comprises the step of:
referencing area and shape of frontal surfaces of a plurality of trailer types retained in a trailer type database.

14. The method of claim 9, wherein step (D) comprises the step of:
referencing trailer specifications associated with the identified trailer type retained in a trailer specification database.

15. The method of claim 14, wherein the step of, referencing trailer specifications associated with the identified trailer type retained in a trailer specification database, comprises the step of:
referencing correlated information comprising at least one of empty trailer weight, trailer weight capacity, center of gravity, and aerodynamic drag as a function of vehicle speed.

16. The method of claim 9, wherein step (F) comprises the step of:
modifying drive train control functions performed by the vehicle control unit.

17. The method of claim 16, wherein the step of, modifying drive train control functions performed by the vehicle control unit, comprises the step of:
modifying at least one of automatic transmission timing, active suspension and brake controls for sway dampening, engine power vs. fuel consumption adjustments, and cruise control feedback gains.

18. The method of claim 9, wherein:
step (B) comprises the step of: estimating a shape of the frontal surface of the trailer from the captured image; and,
step (C) comprises the step of: identifying a type of trailer from the shape of the frontal surface of the trailer;

19. The method of claim 9 wherein prior to steps (E) and (F) the method comprises the step of:
retrieving correlated information related to the trailer based on the type of trailer identified.

20. A system of operating a vehicle towing a trailer comprising:
means for capturing an image of a frontal surface of the trailer;
means for estimating an area and shape of the frontal surface of the trailer from the captured image;
means for identifying a type of trailer from the estimated area and shape of the frontal surface of the trailer;
means for retrieving correlated information related to the trailer based on the type of trailer identified;
means for transmitting the correlated information to an on-board vehicle control unit; and
means for modifying the operation of the vehicle according to the correlated information.
